(19) United States
(12) Patent Application Publication
(10) Pub. No.: US 2006/0254460 A1
(43) Pub. Date: Nov. 16, 2006

(54) Solid water-free composite material

(75) Inventors: Ralf Noerenberg, Ingelheim (DE); Michael Gotsche, Mannheim (DE); Hans-Peter Seelmann-Eggebert, Limburgerhof (DE); Paul Klingelhofer, Mannheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellshaft, Ludwigshafen (DE)

(21) Appl. No.: 10/570,662

(22) PCT Filed: Sep. 9, 2004
(86) PCT No.: PCT/EP04/10064

§ 371 Date: Mar. 6, 2006

(30) Foreign Application Priority Data
Sep. 10, 2003 (DE) 103 41 725.7

(51) Int. Cl. C09D 11/00

(52) U.S. Cl. 106/31.86

(57) ABSTRACT

A solid, water-free and alkanol-free composite material comprises organic and/or inorganic water-insoluble particles or pigments in a mixture with at least one compound of the general formula (I)
CₙH₂ₙ₊₁O(A)ₓ(B)_{y}R (I) where
R is H, C₁₋₆ alkyl or benzyl A is ethyleneoxy
B is C₃₋₁₀ alkyleneoxy or mixtures thereof, it being possible for groups A and B to be randomly distributed, alternating or in the form of two or more blocks in any order, n is an integer in the range from 4 to 8 x is a number in the range from 1 to 25 y is a number in the range from 0 to 10 and x+y is at least 1.

The invention relates to solid, water- and alcohol-free composite materials, to processes for producing them, to their use as a filler and/or dye and/or for preparing aqueous dispersions, and also to further uses and to formulations comprising the composite materials.

The rapid wetting of surfaces plays a key role in many areas of everyday life and in numerous industrial operations, as for example in papermaking or the coating of substrates. In many formulations, therefore, varying amounts of alcohols such as ethanol or isopropanol are used in order to lower the surface tension, for example, and so to improve the wetting capacity of the formulations. For formulations which work very rapidly, such as additives for coating formulations, such as for finishing paper by means of a paper coating slip, as it is termed, they represent a necessary ingredient.

One common means of increasing the wetting rate of aqueous formulations is to use surfactants, which accumulate at interfaces and, in so doing, lower the interfacial tension. Whereas addition of alcohols such as ethanol or isopropanol to aqueous formulations gives the resultant water/solvent mixture a surface tension lower than that of water, and hence improved wetting behavior, wetting or surface coverage in the case where surfactant systems are used is time-dependent. The surfactant molecules must first diffuse to the surface and build up an interfacial film thereon, which lowers the interfacial tension or surface tension on contact with water and air. In the case of very rapid processes such as wetting processes, for instance, the time within which the surface or interfacial tension is lowered to the equilibrium value by the surfactant system is critical. The dynamics of the surfactant system are of great importance for the wetting rate.

Presently ethoxylates of lower alcohols are used as wetting agents. As an inevitable result of their preparation, however, such products frequently include quantities of alcohol, which in turn contributes critically to the rapid wetting and in the case of very short wetting times may be the sole wetting component.

The use of alkyl glycol alkoxylates or alkyl diglycol alkoxylates, which are obtainable by alkoxylating C₄₋₈ alkyl glycols or diglycols with C₂₋₅ alkoxides to an average degree of alkoxylation of from 1 to 8, based on C₄₋₈ alkyl glycols or diglycols, in aqueous formulations is known from WO 03/60049.

Detergents or cleaning products which can comprise a combination of surfactants with alkanol alkoxylates are described for example in WO 01/32820. The compositions described therein further comprise solid particles with a size of 5 to 500 nm. The glycol ethers described in the WO application are described therein as hydrophilicizing agents.

Numerous applications use pigments as inexpensive fillers and to impart whiteness. Examples that may be mentioned include papermaking, paper finishing, paints and fluids.

The use of inexpensive fillers in the mostly aqueous applications is a central objective of the manufacturers. Talc, for example, is an inexpensive but very hydrophobic pigment which can be used only if it can be stabilized in aqueous formulations. Other hydrophobic pigments too, like dyes, are frequently difficult to stabilize in aqueous systems.

It is an object of the present invention to provide composite materials which comprise organic and/or inorganic water-insoluble particles or pigments, which exhibit improved wetting behavior and which are easy to incorporate into a multiplicity of formulations.

This object is achieved in accordance with the invention by means of a solid, water-free composite material comprising organic and/or inorganic water-insoluble particles or pigments in a mixture with at least one compound of the general formula (I)
CₙH₂ₙ₊₁O(A)ₓ(B)_{y}R (I)
where
R is H, C₁₋₆ alkyl or benzyl
A is ethyleneoxy
B is C₃₋₁₀ alkyleneoxy or mixtures thereof,
it being possible for groups A and B to be randomly distributed, alternating or in the form of two or more blocks in any order,
n is an integer in the range from 4 to 8
x is a number in the range from 1 to 25, preferably 2 to 12, more preferably 2 to 10, in particular 3 to 8
y is a number in the range from 0 to 10
and x+y is at least 1.

According to one embodiment of the invention the solid, alcohol-free or alkanol-free and water-free composite material is composed of the stated particles and compounds of the general formula (I).

The particles may be present preferably in an amount in the range from 85 to 99.9% by weight, more preferably from 90 to 99.5% by weight, and the compounds of the general formula (I) in an amount in the range from 0.1 to 15% by weight, preferably from 0.5 to 10% by weight, based on the total amount of the composite material.

The particles or pigments may be selected from organic and inorganic particles or pigments or mixtures thereof. Examples of inorganic particles or pigments are talc, calcium carbonates, kaolin, titanium dioxide, gypsum, chalk, carbon black or synthetic pigments, such as iron oxides, optical brighteners, e.g., zinc oxide, alone or in mixtures. They also include disperse dyes and pigment dyes, e.g., Disperse Red 60, Disperse Yellow 54, Disperse Blue 72, Disperse Blue 359, Disperse Blue 60, Pigment Orange 34, Pigment Red 146, Pigment Red 170, Pigment Yellow 138, Pigment Yellow 83, Pigment Green 7, Pigment Blue 15:0, Pigment blue 15:1 and Pigment Blue 15:3, Pigment Violet 23, Pigment Red 122, and also Pigment Black 7, Pigment White 6 and Pigment Red 101. Organic optical brighteners as well, such as stilbenes, for example, can be used.

The particles and pigments preferably have a particle size in the range from 0.05 to 500 μg/m, more preferably from 0.05 to 50 μm, with further preference from 0.05 to 1 μm. The expression “water-insoluble” refers to the fact that the organic or inorganic particles or pigments have a water solubility of less than 0.1 g/l, preferably less than 0.01 g/l at 25° C.

The expression “water-free” refers to those composite materials which apart from water bound to the particles or pigments by adhesion, or water of crystallization present in the particles or pigments, contain no further water and in particular no added water. The compounds of the general formula (I) likewise contain no water, in particular no added water, apart from traces which are difficult to separate from the compounds of the general formula (I). Where the particles or pigments are treated with an aqueous solution of the compound of the general formula (I), the expression “water-free” refers to a product obtained after treatment by customary drying techniques.

The expression “alkanol-free” refers to composite materials with no gas-chromatographically (GC) measurable amounts of alkanols, especially CₙH₂ₙ₊₁OH.

The expression “solid” refers to a composite material which is solid at 25° C., and delimits the composite material of the invention from those materials present in the form of a solution or dispersion.

In the compounds of the general formula (I) n is an integer in the range from 4 to 8, preferably from 5 to 8. x is a number in the range from 0 to 25, preferably 3 to 12. y is a number from 0 to 10, preferably 0, 1 or 2.

R has the definition hydrogen, linear or branched C₁₋₆ alkyl, preferably linear C₁₋₃ alkyl, especially methyl or ethyl, or benzyl. With particular preference R is hydrogen or methyl.

B denotes C₂₋₁₀ alkyleneoxy or mixtures thereof, preferably C₃₋₅ alkyleneoxy or mixtures thereof. Particular preference is given to propyleneoxy and butyleneoxy, especially propyleneoxy.

The radical CₙH₂ₙ₊₁ may comprise linear or singly or multiply branched alkyl radicals, the presence of mixtures of linear or branched alkyl radicals also being possible. With particular preference the alkyl radical is linear and hence terminal.

The compounds of the general formula (I) used in accordance with the invention are obtained for example by alkoxylating alcohols of the general formula CₙH₂ₙ₊₁OH with alkylene oxides, which correspond to the units A and B. Where R is other than hydrogen, the alkoxylation may be followed by an etherification. The alkoxylation and any subsequent purification of the alkoxylation product are conducted in such a way that the alkoxylates are alkanol-free.

The values of x and y are average values, since the alkoxylation of alkanols generally produces a distribution in the degree of alkoxylation. Therefore it is possible for x and y to deviate from integral values. The distribution of the degree of alkoxylation can be adjusted to a certain extent by using different alkoxylation catalysts. If not only ethylene oxide but also one or more longer-chain alkylene oxides are used for the alkoxylation then the different alkylene oxide radicals may be randomly distributed, alternating or in the form of two or more blocks in any order. With particular preference alkoxylation is carried out only with ethylene oxide, so that the radical is a pure (poly)ethylene oxide radical. The average value of the homologous distribution is represented by the indicated numbers x and y.

The alkoxylation can be carried out, for example, using alkaline catalysts such as alkyl metal hydroxides or alkali metal alcoholates. Use of these catalysts results in specific properties, particularly the distribution of the degree of alkoxylation.

The alkoxylation can also be carried out using Lewis-acidic catalysis, with the resultant specific properties, particularly in the presence of BF₃×H₃PO₄, BF₃ dietherate, BF₃, SbCl₅, SnCl₄×2H₂O, hydrotalcite. Catalyst suitability is also possessed by double metal cyanide (DMC) compounds.

The excess alcohol can be removed by distillation, or the alkoxylate can be recovered by a two-step operation. Also possible is the preparation of mixed alkoxylates of, say, EO and PO, in which case the alkanol radical may be followed first by a propylene oxide block and an ethylene oxide block, or first an ethylene oxide block and then a propylene oxide block. Random/statistical distributions are also possible. Preferred reaction conditions are indicated below.

The alkoxylation is preferably catalyzed by strong bases, which are added advantageously in the form of an alkali metal hydroxide or alkaline earth metal hydroxide, generally in an amount of from 0.1 to 1% by weight, based on the amount of the alkanol R2-OH (cf. G. Gee et al., J. Chem. Soc. (1961), p. 1345; B. Wojtech, Makromol. Chem. 66 (1966), p. 180).

Acidic catalysis of the addition reaction is also possible. Besides Bronsted acids Lewis acids, too, are suitable, such as AlCl₃ or BF₃ (cf. P. H Plesch, The Chemistry of Cationic Polymerization, Pergamon Press, New York (1963)).

As DMC compound it is possible in principle to use all of the suitable compounds known to the skilled worker.

DMC compounds with catalyst suitability are described for example in WO 99/16775 and DE-A-101117273. Particularly suitable as catalyst for the alkoxylation are double metal cyanide compounds of the general formula:
M¹ₐ[M²(CN)_{b}(A)_{c}]_{d}.fM¹_{g}Xₙ.h(H₂O).eL.kP,
in which
M¹ is at least one metal ion selected from the group consisting of Zn²⁺, Fe²⁺, Fe³⁺, C³⁺, Ni²⁺, Mn²⁺, Co²⁺, Sn²⁺, Pb²⁺, Mo⁴⁺, Mo⁶⁺, Al³⁺, V⁴⁺, V⁵⁺, Sr^{2′}, W⁴⁺, W⁶⁺, Cr²⁺, Cr³⁺, Cd²⁺, Hg²⁺, Pd²⁺, Pt²⁺, V²⁺, Mg²⁺, Ca²⁺, Ba²⁺, Cu²⁺, La³⁺, Ce³⁺, Ce⁴⁺, Eu³⁺, Ti³⁺, Ti⁴⁺, Ag⁺, Rh²⁺, Rh³⁺, Ru²⁺ and Ru³⁺,
M² is at least one metal ion selected from the group consisting of Fe²⁺, Fe³⁺, Co²⁺, Co³⁺, Mn²⁺, Mn³⁺, V⁴⁺, V⁵⁺, Cr²⁺, Cr³⁺, Rh³⁺, Ru²⁺ and Ir³⁺,
A and X independently of one another are each an anion selected from the group consisting of halide, hydroxide, sulfate, carbonate, cyanide, thiocyanate, isocyanate, cyanate, carboxylate, oxalate, nitrate, nitrosyl, hydrogensulfate, phosphate, dihydrogenphosphate, hydrogenphosphate or hydrogencarbonate,
L is a water-miscible ligand selected from the group consisting of alcohols, aldehydes, ketones, ethers, polyethers, esters, polyesters, polycarbonate, ureas, amides, primary, secondary and tertiary amines, ligands with pyridine nitrogen, nitriles, sulfides, phosphides, phosphates, phosphanes, phosphonates and phosphates,
k is a fractional or integral number greater than or equal to zero, and
P is an organic additive,
a, b, c, d, g and n are selected such as to ensure the electroneutrality of the compound (I), it being possible for c to be 0,
e is the number of ligand molecules, a fractional or integral number greater than 0 or 0,
f, h and m independently of one another are a fractional or integral number greater than 0 or 0.

Organic additives P include the following: polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinylmethyl ketone, poly(4-vinylphenol), poly(acrylic acid-co-styrene), oxazoline polymers, polyalkylenimines, maleic acid copolymers and maleic anhydride copolymers, hydroxyethylcellulose, polyacetates, ionic surface-active and interface-active compounds, gallic acid or the salts, esters or amides thereof, carboxylic esters of polyhydric alcohols, and glycosides.

These catalysts may be crystalline or amorphous. If k is zero preference is given to crystalline double metal cyanide compounds. If k is greater than zero preference is given to crystalline, semicrystalline and substantially amorphous catalysts.

Of the modified catalysts there are a variety of preferred embodiments. One preferred embodiment are catalysts of the formula in which k is greater than zero. The preferred catalyst then comprises at least one double metal cyanide compound, at least one organic ligand and at least one organic additive P.

In another preferred embodiment k is zero, optionally e is zero too and X is exclusively a carboxylate, preferably formate, acetate and propionate. Catalysts of this kind are described in WO 99/16775. In this embodiment preference is given to crystalline double metal cyanide catalysts. Further preference is given to double metal cyanide catalysts as described in WO 00/74845 which are crystalline and platelet-shaped.

The modified catalysts are prepared by combining a metal salt solution with a cyanometallate solution which optionally may contain not only an organic ligand L but also an organic additive P. Subsequently the organic ligand and optionally the organic additive are added. In one preferred embodiment of catalyst preparation an inactive double metal cyanide phase is prepared first of all and is subsequently converted by recrystallization into an active double metal cyanide phase, as described in PCT/EP01/01893.

In another preferred embodiment of the catalysts f, e and k are other than zero. These are double metal cyanide catalysts containing a water-miscible organic ligand (generally in amounts of from 0.5 to 30% by weight) and an organic additive (generally in amounts of from 5 to 80% by weight) as described in WO 98/06312. The catalysts can be prepared either with vigorous stirring (24 000 rpm with Turrax) or with stirring as described in U.S. Pat. No. 5,158,922.

Particularly suitable alkoxylation catalysts are double metal cyanide compounds containing zinc, cobalt or iron or two of these. Particular suitability is possessed, for example, by Prussian Blue.

Preference is given to using crystalline DMC compounds. In one preferred embodiment a crystalline DMC compound of the Zn—Co type is used as catalyst that contains zinc acetate as a further metal salt component. Compounds of this kind crystallize in a monoclinic structure and have a platelet-shaped habit. Compounds of this kind are described for example in WO 00/74845 or PCT/EP01/01893.

DMC compounds with catalyst suitability can be prepared in principle by all of the methods known to the skilled worker. The DMC compounds can be prepared, for example, by direct precipitation, by the “incipient wetness” method, or by preparing a precursor phase with subsequent recrystallization.

The DMC compounds can be used as powder, paste or suspension or can be shaped to a molding, incorporated into moldings, foams or the like or applied to moldings, foams or the like.

The catalyst concentration used for the alkoxylation, relative to the final quantitative parameters, is typically less than 2000 ppm, preferably less than 1000 ppm, in particular less than 500 ppm, more preferably less than 100 ppm, and for example less than 50 ppm.

The addition reaction is performed in a closed vessel at temperatures of about 90 to about 240° C., preferably from 120 to 180° C. The alkylene oxide or the mixture of different alkylene oxides is supplied to the mixture of inventive alkanol mixture and alkali under the prevailing vapor pressure of the alkylene oxide mixture at the chosen reaction temperature. If desired the alkylene oxide can be diluted with up to about 30 to 60% with an inert gas. This provides additional security against explosive polyaddition of the alkylene oxide.

If an alkylene oxide mixture is used then polyether chains are formed in which the distribution of the different alkylene oxide building blocks is virtually random. Variations in the distribution of the building blocks along the polyether chain arise as a result of different reaction rates of the components and may also be achieved arbitrarily by continuously supplying an alkylene oxide mixture whose composition is under program control. When the different alkylene oxides are reacted in succession, polyether chains are obtained with a blockwise distribution of the alkylene oxide building blocks.

The length of the polyether chains varies randomly within the reaction product around an average value which corresponds essentially to the stoichiometric value resulting from the amount added.

As compounds of the general formula (I) it is also possible to use alkyl glycol alkoxylates or alkyl diglycol alkoxylates, which are obtainable by alkoxylating C₄₋₈ alkyl glycols or diglycols with C₂₋₅ alkoxides, preferably up to an average degree of alkoxylation of from 1 to 11 or from 0 to 10, based on the C₄₋₈ alkyl glycols or diglycols.

The remarks below refer equally to alkyl diglycols and to alkyl glycols and the alkoxylates thereof.

These alkyl glycols can be linear or branched alkyl glycols. The attachment of the C₄₋₈ alkyl radical to the glycol can be terminal or at any other position along the alkyl chain. The compounds are preferably linear alkyl glycols, especially linear, terminal alkyl glycols. The alkyl radicals of the alkyl glycols preferably have 4 to 6 carbon atoms. The degree of alkoxylation is on average from 1 to 25, preferably from 2 to 12, based on alkanol. For the alkoxylation it is possible with preference to use C₂₋₄ alkoxides. Preference is given to using ethylene oxide, propylene oxide, butylene oxide or mixtures thereof. Ethylene oxide is used with particular preference. The preferred ranges also refer to the alkyl glycol alkoxylates and alkyl diglycol alkoxylates per se.

The preparation in this case takes place starting from alcohol-free, preferably pure alkyl glycols and alkyl diglycols, and not, as described above, from alkanols, by alkoxylation. The product mixtures therefore also contain no remaining alkanols, but only, at most, alkyl glycols. This produces a distribution in the degree of alkoxylation that is specific to alkyl glycols. As a result of the preparation process the alkyl glycol alkoxylates are free from alcohols.

Alkoxylates are oligomeric or polymeric reaction products with alkoxides. Because of the kinetics of polymerizations, which are known to the skilled worker, there is automatically a random distribution of homologs, whose average is usually reported. The frequency distribution of the homologs includes the starting material, particularly at low degrees of alkoxylation. Although it is possible through the choice of catalysts to influence the distribution to a certain extent, there is no change to the principle of the distribution curve. Pure alkyl oligoglycols can be prepared only by distillative or chromatographic workup and are therefore expensive. Moreover it has been found that the distribution of the homologs as an advantageous influence on the aggregation behavior.

The alkoxylates described in this embodiment possess the homolog distribution which is important for the aggregation behavior and for the other properties according to the invention, without containing alcohol.

The distribution of the degrees of alkoxylation can be determined by chromatographic techniques.

For a comparison between alkanol alkoxylates and alkyl glycol alkoxylates refer to WO 03/60049.

Since the product mixture contains no alcohols it is largely free from odor. The compounds of the formula (I) can be used—particularly in the state of applications—in combination with surfactants. Surfactants which can be used in accordance with the invention are all surfactants which in solution in water at 5 g/l exhibit an interfacial tension of less than 45 mN/m at 20° C. The surfactants can, generally, be alkoxylated alcohols, amides, acids, betaines, amine oxides or amines, but also dihydroxyalkynes and derivatives and mixtures thereof. The rate at which the ultimate level of interfacial tension is established may be dependent on the molecular architecture, such as the chain length and the degree of branching of the alcohol, the length and solvation of the alkoxylate, the surfactant concentration and the surfactant aggregation. Generally speaking, smaller aggregates diffuse more rapidly than do large aggregates.

The surfactants are preferably nonionic surfactants and selected from C₂₋₅, preferably C₂₋₄ alkoxylates of C₉₋₂₀, preferably C₉₋₁₅, in particular C₉₋₁₃ alkanols, having on average a degree of alkoxylation of 3 to 30, preferably 4-15, in particular from 5 to 12, and mixtures thereof. C₉₋₁₁ Alkanols in particular are used to synthesize the surfactants. These can be linear or branched alkanols. In the case of a branched alcohol the degree of branching is preferably in the range from 1.1 to 1.5. The alkoxylation can take place with any desired C₂₋₄ alkoxides and mixtures thereof. Ethylene oxide, propylene oxide or butylene oxide, for example, can be used to alkoxylate. Particular preference is given to using ethylene oxide, propylene oxide or mixtures thereof. Ethylene oxide is especially preferred. The degree of alkoxylation is on average from 3 to 8, preferably from 3 to 6. Nonionic surfactants of this kind are known and are described for example in EP-A 0 616 026 and EP-A 0 616 028. Those publications also mention shorter-chain alkyl alkoxylates.

The nonionic surfactants used may also be replaced by dihydroxyalkynes or derivatives thereof. They may additionally be low-foam or foam-suppressing surfactants; cf. also EP-A 0 681 865. Low-foam and foam-suppressing surfactants are known to the skilled worker.

The above-indicated compounds of the general formula (I) can be applied to the particles or pigments by a variety of known processes. Particular preference is given to dipping and spraying operations, especially fluidized bed processes. A solid, water-free and alkanol-free composite material obtained in this way exhibits significantly improved wetting with polar liquids, particularly water. Therefore the inventively modified particles and pigments can be formulated and processed much more effectively.

The composite materials of the invention are produced, very generally, by mixing the particles or pigments with the compounds of the general formula (I), with heating where appropriate.

The composite materials of the invention are used in accordance with the invention preferably as a filler and/or dye and/or for preparing aqueous dispersions. They are used in particular for producing paper, inks, paints, coatings, formulations for mineral processing or paper finishing.

The invention also relates to paints, ink formulations, coating or overcoating compositions or formulations for mineral processing, papermaking and paper finishing, comprising a composite material of the invention and, if appropriate, surfactants which in solution in water at 5 g/l exhibit an interfacial tension of less than 45 mN/m at 20° C., if appropriate polymers and, if appropriate, customary auxiliaries.

Examples of formulations for papermaking and paper finishing are coating colors and filling pigment formulations.

The formulations of the invention normally include further ingredients such as surfactants or polymers and other ingredients.

The invention is illustrated by the following examples.

### EXAMPLES

### Example 1

100 g of talc powder are admixed with an inventive n-hexanol ethoxylate (hexanol+5 EO) in concentrations of 2%, 5% and 10%, based on the talc weight, and the mixture is homogenized.

This gives a homogeneous, nondusting and noncaking powder which when introduced into water disperses immediately and is partly held in suspension.

| | 0% | 2% | 5% | 10% |
|---|---|---|---|---|
| | alkoxylate | alkoxylate | alkoxylate | alkoxylate |
| Wetting time in s | >300 | <5 | <1 | <1 |

### Example 2

Lead ore is sprayed with an aqueous solution in order to agglomerate and bind the dust fraction. The dust, however, floats. By spraying the ore with a 0.1% strength solution of a pentanol alkoxylate (pentanol+1 PO+5 EO) the dust is fully wetted by the spraying water and bound without floating.

1. A solid, water-free and alkanol-free composite material comprising organic and/or inorganic water-insoluble particles or pigments in a mixture with at least one compound of the general formula (I)
CₙH₂ₙ₊₁O(A)ₓ(B)_{y}R (I)
where
R is H, C₁₋₆ alkyl or benzyl
A is ethyleneoxy
B is C₃₋₁₀ alkyleneoxy or mixtures thereof,
it being possible for groups A and B to be randomly distributed, alternating or in the form of two or more blocks in any order,
n is an integer in the range from 4 to 8
x is a number in the range from 1 to 25
y is a number in the range from 0 to 10
and x+y is at least 1,
wherein the alkoxylation and any subsequent purification of the alkoxylation product are conducted in such a way that the alkoxylates are alkanol-free.

2. The composite material according to claim 1, wherein the particles are present in an amount in the range from 85 to 99.9% by weight and the compounds of the general formula (I) in an amount in the range from 0.1 to 15% by weight, based on the total amount of the composite material.

3. The composite material according to claim 1, wherein the compound of the general formula (I) is an alkyl glycol alkoxylate or alkyl diglycol alkoxylate obtainable by alkoxylating C₄₋₈ alkyl glycols or diglycols with the parent alkylene oxides of the units A and/or B.

4. The composite material according to claim 1, wherein the compound of the general formula (I) is preparable by DMC-catalyzed alkoxylation.

5. A process for producing a composite material according to claim 1 by mixing the organic and/or inorganic water-insoluble particles or pigments and the compounds of the general formula (I) with heating where appropriate.

6. The method of using of a composite material according to claim 1 as a filler and/or dye and/or for preparing aqueous dispersions.

7. The method of using of a composite material according to claim 1 for producing paper, paints, inks, coatings, formulations for mineral processing or paper finishing.

8. A paint, ink formulation, coating or overcoating composition or formulation for mineral processing, papermaking or paper finishing, comprising a composite material according to claim 1 and, if appropriate, surfactants which in solution in water at 5 g/l exhibit an interfacial tension of less than 45 mN/m at 20° C., polymers if appropriate and, if appropriate, customary auxiliaries.

9. The method of using of compounds of the general formula (I) as defined in claim 1 to treat organic or inorganic water-soluble particles or pigments for increasing wettability with polar liquids.
